(19) United States
(12) Patent Application Publication
(10) Pub. No.: US 2013/0182705 A1
(43) Pub. Date: Jul. 18, 2013

(54) METHOD AND SYSTEM FOR TRANSMITTING ENCODED VIDEO SIGNALS

(71) Applicants: Uri Avni, Tel Aviv (IL); Israel Drori, Newton, MA (US)

(72) Inventors: Uri Avni, Tel Aviv (IL); Israel Drori, Newton, MA (US)

(21) Appl. No.: 13/353,044

(22) Filed: Jan. 18, 2012

(51) Int. Cl. H04L 12/56; H04N 7/26; H04N 7/24

(52) U.S. Cl. 370/389; 375/E07.005; 375/E07.02; 375/E07.189

(57) ABSTRACT

A method and systems are provided for transmitting encoded video data over a packet switched network, by: (i) providing a plurality of encoded copies of video data, each encoded at a bitrate different from that of the others; (ii) transmitting one of the copies encoded at a first bitrate from a first end of a communication channel towards a second end of the communication channel; (iii) receiving the encoded copy at the second end and detecting the channel error rate associated therewith; (iv) at the first end, providing an indication associated with the detected error rate to enable transmitting from the first end another encoded copy having a different bitrate; and (v) transmitting a second copy encoded at a second bitrate, wherein the second bitrate is substantially equal to a maximal rate at which that encoded copy is recoverable at the second end with no noticeable apparent errors.

### TECHNICAL FIELD

The present invention relates to a method and a device for transmitting video data. More particularly, it relates to improved transmission of encoded video data over a packet switched network to clients.

### BACKGROUND

When referring to the field of video transmission over a packet switched network, it is well known that the network is non-reliable media since it doesn't ensure stable conditions nor reliable transmission of packets, i.e. transmission rate may be changed (e.g. due to congestion conditions) and packet losses may occur.

The desire for video coding, which allows on-the-fly adaptation to certain application requirements such as display and processing capabilities of target devices, and varying transmission conditions, originates from the continuous evolution of receiving devices and the increasing usage of transmission systems characterized by a widely varying connection quality. Video coding today is used in a wide range of applications ranging from multimedia messaging, video telephony and video conferencing over mobile TV, wireless and Internet video streaming, to standard and high-definition TV broadcasting. In particular, the Internet and wireless networks gain more and more importance for video applications. Video transmission in such systems is exposed to variable transmission conditions, which may be dealt with for example by using scalability features. Furthermore, video content is typically delivered to a variety of decoding devices with heterogeneous display and computational capabilities. In these heterogeneous environments, flexible adaptation of once-encoded content is desirable, while at the same time enabling interoperability of encoder and decoder products from different manufacturers.

A video bit stream is called scalable when parts of the stream can be removed in a way that the resulting sub-stream forms another valid bit stream for some target decoder, and the sub-stream represents the source content with a reconstruction quality that is less than that of the complete original bit stream but is high when considering the lower quantity of remaining data. Bit streams that do not provide this property are referred to as single-layer bit streams.

Several methods are known in the art for adapting a video stream to losses. One possible solution involves separating between the macroblocks of the base layer used for inter-layer prediction (ILP) and the macroblocks of the base layer not used for inter-layer prediction, and transmitting to the client only the macroblocks used for ILP and as much data of the enhancement layers as allowed by the remaining bitrate. In case of partial loss in the enhancement layer, the frames depending on the lost data cannot be decoded. Moreover, when a loss occurs in the enhancement layer, nothing can be decoded in the base layer since this layer has been received only partially. Therefore, no minimum quality can be asserted in case of transmission losses.

Another known solution consists, for the decision engine, selecting the entire base layer (including macroblocks used for ILP and macroblocks not used for ILP), and transmitting part of the enhancement layer according to the available bitrate. However, this solution is not considered to be an optimal solution, since, if there are no losses, more enhancement layer data could be transmitted to improve the quality.

Other methods of adapting a video stream to losses which attempt to avoid the loss configurations described above are also known in the art. One such method comprises generating redundant data in order to retrieve missing data in case of losses. This method is referred to as “FEC” (Forward Error Correction) and includes allocating an amount of redundant data adapted to an estimated loss rate. These FEC can be generated in the form of error correcting codes (for example, Reed-Solomon, Xor, and the like), or in the form of low quality version of the original data to transmit. The efficiency of this method depends on the quality of the loss rate estimation. The loss rate is typically calculated as the number of lost packets divided by the number of transmitted packets during a given period of time. This value is therefore an average value, and cannot represent the variation of the number of losses during this period. For instance, by applying the loss rate, one cannot identify losses spread regularly during the period from losses occurring in bursts of consecutive losses. Since the amount of redundant data is dependent on the loss rate, the FEC are efficient for losses occurring regularly but not that much for losses occurring by bursts which are characterized by high variation of the amount of losses occurring during the measurement period.

Another known solution discloses assigning a priority level to each packet carrying video data payload, where the priority level depends on the data being transported. For example, the priority level may be based on whether the data is used as reference for prediction (in which case the respective packet will have a higher priority as it is more important than packets carrying other data). However, this solution again does not solve the problem of bursts of losses, since high priority packets might be lost with low priority packets if the burst of losses lasts for a sufficiently long period of time.

US 2009046580 describes techniques for overcoming lost packets and avoiding congestion when conducting media conferences over packet switched networks. To avoid the problem of lost packets, redundant information is inserted into the media stream that permits the receiver to reconstruct any lost packets from the redundant information. For the avoidance of congestion the bitrate of the media stream is adjusted to find the highest bitrate that can be supported without packet loss due to congestion.

Adaptive bitrate mechanisms that are commercially available nowadays such as HLS, MPEG-DASH or Microsoft Smooth Streaming are all based on implementing the Transmission Control Protocol (TCP), and hence are not suitable for multicast operations, difficult to achieve low latency therewith, and tend to not utilize the full capacity of the available communication link.

### SUMMARY OF THE DISCLOSURE

The disclosure may be summarized by referring to the appended claims.

It is an object of the present invention to provide a method to allow dynamic switching between multiple-quality streams in order to enable utilizing the highest effective bitrate for a given the link.

It is another object of the present invention to enable dynamic switching between multiple-quality streams to be carried out smoothly between various bitrates without introducing perceivable errors thereat.

It is still another object of the present invention to enable transmission of a video stream at the highest bitrate possible with enough redundancy to ensure reception of such a video stream with fewer errors than a pre-determined error rate.

It is yet another object of the present invention to enable carrying out adaptive streaming techniques, where the source is encoded at a set of given bitrates or as a multi-layered stream, wherein the method provided allows determining the highest possible quality and to switch smoothly between streams of given bitrates.

It is another object of the present invention to provide a method for delivering video content to multiple subscribes with various link qualities.

Other objects of the present invention will become apparent as the description of the invention proceeds.

According to a first embodiment, there is provided a method for transmitting encoded video data over a packet switched network, comprising:
(i) providing a plurality of encoded copies of video data, wherein the plurality of encoded copies comprises at least two copies, each of which is encoded at a bitrate different from a bitrate at which any other of the at least two copies has been encoded (B₁, . . . Bⱼ . . . Bₙ);
(ii) transmitting one of the at least two encoded copies from a first end of a communication channel extending in the packet switched network towards a second end of the communication channel, wherein the transmitted copy is encoded at a first bitrate Bⱼ;
(iii) receiving the encoded copy at the second end of the communication channel and detecting its current error rate E_{detect};
(iv) at the first end of the communication channel, receiving an indication associated with the detected error rate E_{detect}, to enable transmitting from the first end of the communication channel another encoded copy of the at least two encoded copies, having a bitrate different from the first bitrate Bⱼ;
(v) transmitting a second encoded copy of the at least two encoded copies, having a second bitrate, wherein the second encoded copy is selected so that the second bitrate is substantially equal to a maximal rate at which that encoded copy of video data is recoverable at the second end of the communication channel with no noticeable apparent errors.

The term “a plurality of encoded copies”, where each of the copies is encoded at a bitrate which is different from that of the others, is used throughout the specification and claims. However, it should be understood that this term also encompasses mutatis mutandis a multi-layered video having two or more layered streams, so that the bitrates of the copies or of the layered streams in ascending order is B₁, . . . Bⱼ . . . Bₙ. Each copy or quality level is associated with a respective intrinsic error tolerance threshold (E_{1TH}, . . . E_{jTH} . . . E_{nTH}) where E_{jTH} is the maximal rate of errors in the video copy having a bitrate equal to Bⱼ that would still allow tolerable visual quality. The error tolerance thresholds are preferably derived from the communication channel error correction capabilities, the decoding side error concealment capabilities, and from FEC information specific to the video copy or layer, as the case may be.

The term “with no noticeable apparent errors” as used herein and throughout the specification and claims, should be understood to encompass cases where the detected communication error rate, E_{detect}, is lower than the error tolerance threshold E_{jTH}.

According to another embodiment, the maximal rate at which the encoded copy of video data is recoverable at the second end of the communication channel, further comprises a rate at which an error correction code is applied onto the video data.

By yet another embodiment of the method provided, if the detected error rate E_{detect} is equal to or greater than a first error threshold E_{jTH} defined as an error tolerance of the encoded copy transmitted at the first bitrate Bⱼ, then another encoded copy will be transmitted along the communication channel, wherein that other copy is encoded at a bitrate which is lower than the first bitrate Bⱼ.

In accordance with another embodiment, if the detected error rate E_{detect} is less than a first error threshold E_{jTH} defined as error tolerance of the encoded copy transmitted at the first bitrate Bⱼ, the method provided allows for carrying out a bitrate increasing attempt, as the it further comprises a step of associating the encoded copy of the first bitrate Bⱼ with an error correction overhead information being at a second bitrate E_{jOH}, so that the overall transmission rate of the combined streams which is equal to Bⱼ+E_{jOH} is equal to or greater than a second bitrate Bⱼ₊₁ associated with another encoded copy or additional quality layer, and in case an encoded copy which is transmitted at the rate of Bⱼ+E_{jOH} is received at the second end of the communication channel at a measured error rate lower than a second error threshold E_{j+1TH} defined as the error tolerance of an encoded copy transmitted at a second bitrate Bⱼ₊₁, then another encoded copy of the at least two encoded copies will be transmitted along the communication channel, where the latter copy is encoded at a bitrate (Bⱼ₊₁) which is higher than the first bitrate Bⱼ.

As will be appreciated by those skilled in the art, the steps described herein for determining whether a higher bitrate may be applied as the second bitrate for a given communication channel, may be repeated in order to establish whether a still higher (e.g. Bⱼ₊₂) may be applied as the bitrate for transmitting the encoded copy of video data along the given communication channel, as long as the detected error is less than the respective error rate threshold (e.g. of E_{j+2TH}).

According to yet another embodiment of the invention, each of the at least two encoded copies are characterized as being either multiple synchronized single-bitrate streams each having its respective quality, or as a multi-layered single video streams.

In accordance with still another embodiment, the method provided is adapted for multicasting video data to a plurality of end users, associated with different communication channels, where these different communication channels operate under different operating conditions (e.g. have different qualities) by making the FEC overhead streams E_{jOH(j=1 . . . n-1)} available as multicast channels in addition to the original channels.

By yet another embodiment, the maximal rate may change dynamically along with changes occurring at the communication channel, such as changes in the quality of the communication channel (and hence the allowable rate for transmission along that channel).

In accordance with another embodiment, the FEC transformation used is a member selected from the group consisting of: parity codes, Reed-Solomon codes, LDPC codes, Tornado codes, fountain codes and the like.

According to another embodiment, step (c) of the method is affected after having detected a valid transition point at the video stream being conveyed, such as a Group of Pictures (“GOP”) start. Once a valid entry point is detected, the system will preferably stop transmitting stream of encoded copies at a bitrate Bⱼ, and seamlessly start to send stream of copies encoded at a different bitrate, e.g. at Bⱼ₊₁.

According to a second aspect, there is provided a system for transmitting encoded video data over a packet switched network, wherein said system comprises:

means for obtaining a plurality (n) of encoded copies of the video data, wherein the plurality of encoded copies comprises at least two copies or layers, each of which is encoded at a bitrate different from a bitrate at which any other of the at least two copies or layers has been encoded (B₁, . . . Bⱼ . . . Bₙ);

at least one processor operative to apply an appropriate FEC transformation onto at least one of the encoded data streams, so that applying such a transformation onto a video data copy encoded at a bitrate Bⱼ results in an encoded copy having a bitrate greater than or equal to a next bitrate Bⱼ₊₁;

at least one transmission means located at a first end of a communication channel extending in the packet switched network and adapted to transmit one of the at least two encoded copies encoded at a first bitrate Bⱼ towards a second end of the communication channel;

at least one receiver located at a second end of the communication channel, adapted to receive the encoded copy and to detect an error rate E_{detect} associated therewith;

at least one processor operative to enable providing an indication associated with the detected error rate, to enable transmitting another encoded copy of the at least two encoded copies by the at least one transmission means, wherein the other encoded copy has a bitrate different from the first bitrate Bⱼ;

and wherein the at least one transmission means is further operative to transmit a second encoded copy of the at least two encoded copies, having a second bitrate, wherein the second encoded copy is selected so that the second bitrate is substantially equal to a maximal rate at which that encoded copy of video data is recoverable at the second end of the communication channel with no noticeable apparent errors.

According to another embodiment of this aspect, the maximal rate at which the encoded copy of video data is recoverable at the second end, further comprises a rate at which an error correction code is applied onto the video data.

By yet another embodiment, if the detected error rate E_{detect} is equal to or greater than a first error threshold E_{jTH} defined as the error tolerance of the encoded copy transmitted at the first bitrate Bⱼ, then the at least one transmission means is operative to transmit another encoded copy along the communication channel, wherein the other copy is encoded at a bitrate which is lower than the first bitrate Bⱼ.

According to still another embodiment, if the detected error rate E_{detect} is less than a first error threshold E_{jTH} defined as error tolerance of the encoded copy transmitted at the first bitrate Bⱼ, at least one processor is operate to associate the encoded copy of the first bitrate Bⱼ with an error correction overhead information being at a second bitrate E_{jOH}, so that the overall rate of the combined streams which is equal to Bⱼ+E_{jOH} is equal to or greater than a second bitrate Bⱼ₊₁ associated with another encoded copy or an additional quality layer, wherein the at least one transmission means is further operative to transmit another encoded copy at the rate of Bⱼ+E_{jOH} wherein in case the at least one receiver which is further operative to receive another encoded copy at the rate of Bⱼ+E_{jOH}, detects a measured error rate lower than a second error threshold E_{j+1TH} defined as the error tolerance of an encoded copy transmitted at a second bitrate Bⱼ₊₁, then the at least one transmitting means is further operative to transmit another encoded copy, where the latter copy is encoded at a bitrate which is higher than the first bitrate Bⱼ.

In accordance with another embodiment, the maximal rate changes dynamically along with changes occurring at the communication channel.

According to a third aspect, there is provided a non-transitory computer-readable storage media storing one or more sequences of instructions which when loaded and executed by a computer system cause one or more processors to perform:
(i) obtaining a plurality of encoded copies of video data, wherein the plurality of encoded copies comprises at least two copies or layers, each of which is encoded at a bitrate different from a bitrate at which any other of the at least two copies has been encoded (B₁, . . . Bⱼ . . . Bₙ);
(ii) selecting one of the at least two encoded copies to be transmitted from a first end of a communication channel extending in the packet switched network towards a second end of the communication channel, wherein the selected copy is encoded at a first bitrate Bⱼ;
(iii) receiving an indication characterizing an error rate E_{detect} that has been detected at the second end of the communication channel for the selected copy of the first bitrate Bⱼ;
(iv) based on the indication received, selecting a second encoded copy of the at least two encoded copies, having a bitrate different from the first bitrate Bⱼ, to be transmitted from the first end of the communication channel towards the second end thereof, wherein said second encoded copy is selected so that the second bitrate is substantially equal to a maximal rate at which that encoded copy of video data is recoverable at said second end with no noticeable apparent errors.

In accordance with still another embodiment of this aspect, if the detected error rate E_{detect} is equal to or greater than a first error threshold E_{jTH} defined as the error tolerance of the encoded copy selected at the first bitrate Bj, then
another encoded copy will be selected for transmission along said communication channel, wherein that other copy is encoded at a bitrate which is lower than the first bitrate Bⱼ, and

if the detected error rate E_{detect} is less than a first error threshold E_{jTH} defined as the error tolerance of the encoded copy selected at the first bitrate Bⱼ, then:
associating the encoded copy of the first bitrate Bⱼ with an error correction overhead information being at a second bitrate E_{OH}, so that the overall rate of the combined streams which is equal to Bⱼ+E_{jOH} is equal to or greater than a second bitrate Bⱼ₊₁ associated with another encoded copy or an additional quality layer, and in case an indication is obtained that an encoded copy which is transmitted at the rate of Bⱼ+E_{jOH} was received at the second end of the communication channel at a measured error rate lower than a second error threshold E_{j+1TH} defined as the error tolerance of an encoded copy transmitted at a second bitrate Bⱼ₊₁, then another encoded copy of said at least two encoded copies will be selected for transmission along said communication channel, where the latter copy is encoded at a bitrate which is higher than the first bitrate Bⱼ.

According to a fourth aspect, the present invention relates to an information carrier readable by a computer or a microprocessor, removable or not, storing instructions of a computer program, characterized in that it enables the implementation of the method of the present invention as succinctly set forth above.

### BRIEF DESCRIPTION OF THE DRAWINGS

For a more complete understanding of the present invention, reference is made to the following detailed description taken in conjunction with the accompanying drawings wherein:

FIG. 1—illustrates a schematic overview of an embodiment of a system of the present invention; and

FIG. 2—is a flow chart demonstrating an embodiment of a method carried out in accordance with the present invention.

### DETAILED DESCRIPTION

The principles and operation of the method and system according to the present invention may be better understood with reference to the accompanying drawings and the following description that illustrate some specific non-limiting examples of preferred embodiments.

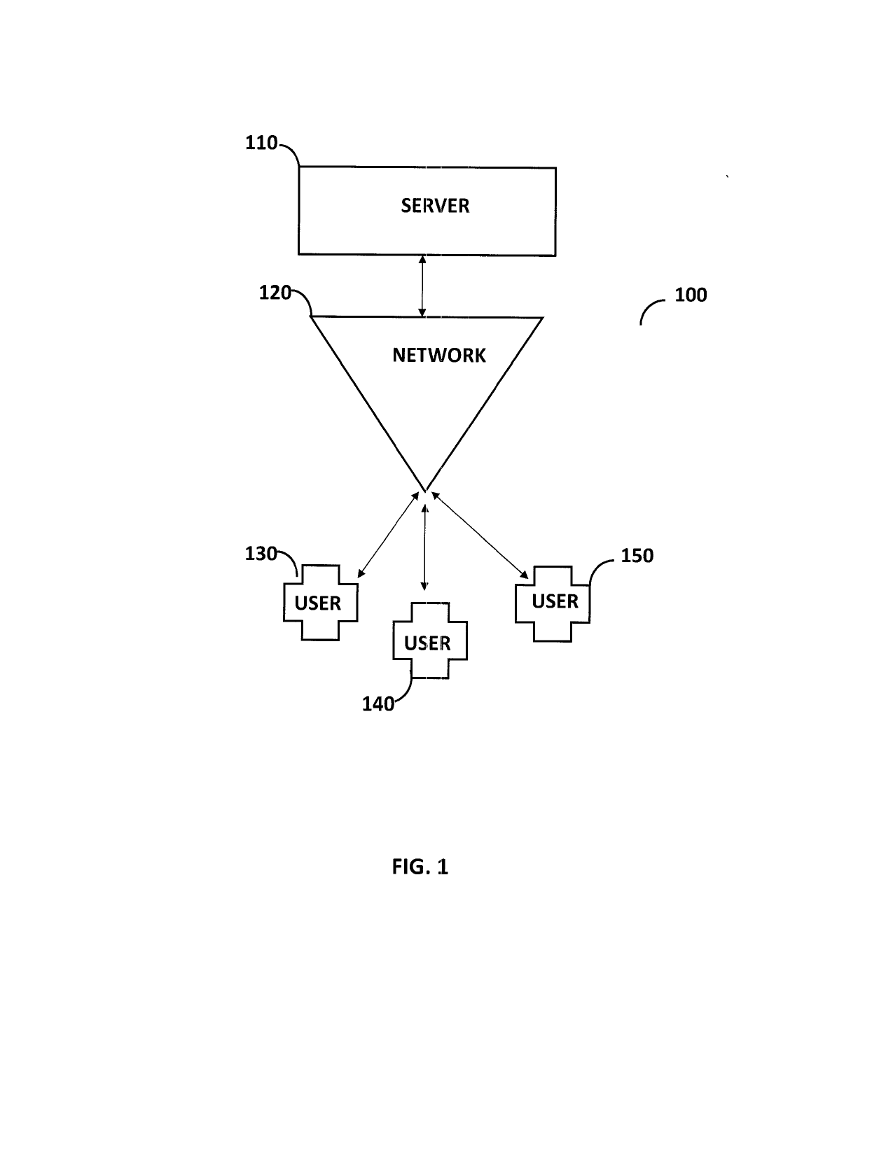

FIG. 1 illustrates an exemplified system in accordance with an embodiment of the present invention, which applies adaptive streaming technique, where the source is already encoded at a set of given bitrates. The system is adapted to enable using the highest possible quality for conveying the content, along with a smooth transition between streams of given bitrates. Furthermore, the system may be used for delivering content to multiple subscribes along links having various link qualities.

System 100 comprises one or more servers 110 which may have for example the functionality of a SCV server (SVCS) and/or of Multipoint Control Unit (MCU), a network 120 (e.g. a packet switched network), another server 130 and a plurality of end-user terminals 140-160. The network enables communication between server 130 and end-user terminals 140-160. Although this example is demonstrated for an SVC type of system, it should be clear that any applicable encoding standard may be used such as AVC, MPEG2, and the like.

One of the functionalities of server 110 is to carry out the SVC standard, thereby to enable the encoding of a high-quality video bitstream that contains one or more subset bitstreams that can themselves be decoded with a complexity and reconstruction quality similar to that achieved using the existing H.264/MPEG-4 AVC design with the same quantity of data as in the subset bitstream. The subset bitstream is typically derived by dropping packets from the larger bitstream.

A subset bitstream can represent a lower spatial resolution, or a lower temporal resolution, or a lower quality video signal (each separately or in combination) compared to the bitstream it is derived from.

Let us now consider for this example that the video data provided at server 110, has been encoded resulting in multiple qualities data stream, which may be either in the form of multiple synchronized single-bitrate streams at multiple qualities, or as a multi-layered single video stream.

The connection between server 130 at the and each of the end users 140 to 160, comprises a number of communication channels, preferably, suitable for datagram based erasure channels, along which an encoded copy of the video stream may be conveyed, wherein each of the channels is preferably adapted to convey a video stream that has been encoded at a bitrate different from the bitrates at which the other video streams transmitted from server 110 to the respective end users, have been encoded.

Server 110 comprises means 160 for obtaining a plurality (n) of encoded copies of the video data, and in the alternative means 160 obtain pre-encoded copies of the video data, in which case server 110 further comprises one or more encoders operative to encode the pre-encoded copies at different bitrates (B₁, . . . Bⱼ . . . Bₙ).

Server 110 further comprises at least one processor operative to apply an appropriate FEC transformation onto at least one of the encoded video data streams, so that applying such a transformation onto a video data copy encoded at a bitrate Bⱼ₋₁ results in an encoded copy having a bitrate equal to or greater than Bⱼ. As will be appreciated by those skilled in the art, in case that server 110 comprises one or more encoders, the above functionality (i.e. applying the appropriate FEC transformation) may be carried out by the one or more encoders.

In addition server 110 also comprises at least one transmitter 170, for transmitting the encoded copies along network 120 towards server 130, while server 130 comprises at least one receiver 180 to receive the encoded copies transmitted by server 110, at least one decoder 190 to decode the received encoded copies and at least one processor 195 to detect error rates associated with the decoded copies.

As previously explained, one of the goals of the present invention is to enable transmission of video data at the maximal rate at which the video data at the receiving end is fully recoverable with the error correction mechanism used, with some additional information that allows additional error recovery beyond the measured rate.

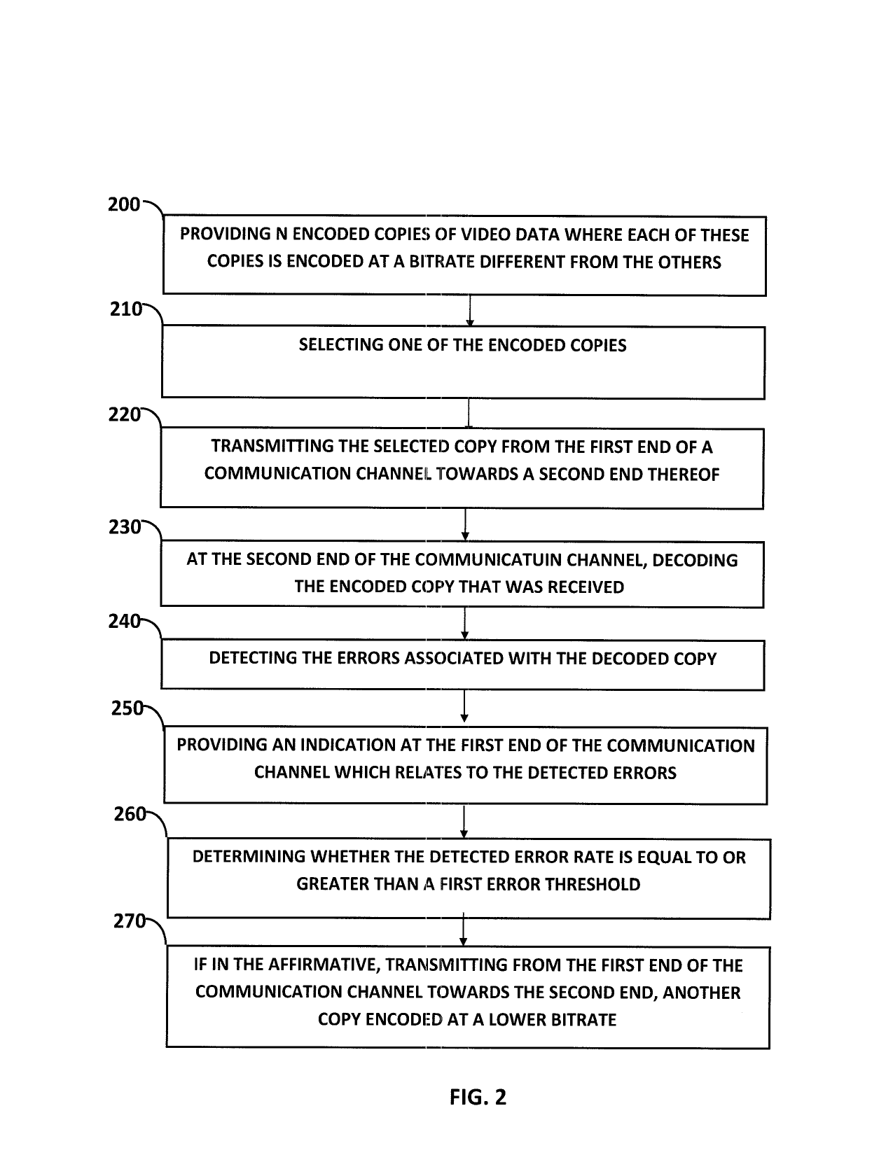

FIG. 2 demonstrates a method of carrying out an embodiment of the present invention for transmitting encoded video data over a packet switched network in the system described in FIG. 1.

In step 200 of this example, a plurality of encoded copies of video data are provided. This plurality of encoded copies comprises a number of copies, where each of the copies is encoded at a different bitrate from the bitrate at which the other copies have been encoded (B₁, . . . Bⱼ . . . Bₙ). After selecting one of the encoded copies (step 210) (e.g. the one that has been encoded at the bitrate Bⱼ, the selected copy is transmitted (step 220) from a first end of a communication channel extending in the packet switched network towards a second end of that communication channel. Once the transmitted encode copy is received at the second end of the communication channel, the copy is decoded (step 230) and the errors associated with the decoded copy are detected (step 240). The detected errors are preferably translated into an error rate E_{detect} which characterizes the received copy of the bitrate Bⱼ.

Next, at the first end of the communication channel, an indication is provided (step 250) (e.g. transmitted from the second end of the channel), wherein this indication relates to the detected error rate. Upon receiving the indication, it is determined (step 260) whether the detected error rate E_{detect} is equal to or greater than a first error threshold E_{jTH} defined as error tolerance of the encoded copy transmitted at the first bitrate Bⱼ. If in the affirmative, then another encoded copy will be transmitted along the communication channel (step 270), where this other copy is encoded at a bitrate which is lower than the first bitrate Bⱼ, to ensure that the video data copy when decoded at the second end would be at such a quality that ensures that no noticeable apparent errors are associated with the decoded copy.

In summary, if the measured error rate approaches or exceeds the recovery capability of the error correcting code of the stream at bitrate Bⱼ, the communication channel reduces the quality to a second copy of the video data that had been encoded at a bitrate lower than the first bitrate Bⱼ.

However, if the detected error rate E_{detect} is less than a first error threshold E_{jTH} defined as error tolerance of the encoded copy transmitted at the first bitrate Bⱼ, this fact indicates that the communication channel conditions allow conveying therethrough copies of the video data that were encoded at a higher bitrate. In this case, an error correction overhead information being at a second bitrate E_{jOH}, will be associated with the encoded copy of the first bitrate Bⱼ (step 300), bringing the overall transmission rate of the combined streams to be equal to Bⱼ+E_{jOH} which is equal to or greater than a second bitrate Bⱼ₊₁ associated with another one of the encoded copies.

Next, the encoded copy having a bitrate of Bⱼ+E_{jOH} is transmitted (step 310) and if that encoded is received at the second end of the communication channel at a measured error rate lower than a second error threshold E_{j+1TH} defined as the error tolerance of an encoded copy transmitted at a second bitrate Bⱼ₊₁ (step 320), then upon informing the transmitting side of the error rate measured (step 330), another one of the encoded copies is transmitted (step 340) along the communication channel, wherein this latter copy is encoded at a bitrate which is higher than the first bitrate Bⱼ (e.g. at Bⱼ₊₁).

In summary, according to this example, periodically an error correction overhead at bitrate Eₖ is added to the bitstream at bitrate Bₖ that brings the total transmission speed to Bₖ+Eₖ>=Bₖ₊₁. If this transmission speed results in a measured error rate at the receiving side which is lower than that of the recovery capabilities of the bitstream at bitrate Bₖ₊₁, a bitstream Bₖ₊₁ should be used instead of Bₖ+Eₖ.

One of the difficulties associated with the conveyance of video data along such a communication channel in a packet switched network, is the transient conditions the often characterize the way a channel communication operates. Therefore, the process described above should be repeated from time to time following changes that occur at the communication channel, as in order to ensure a good utilization of the available resources (e.g. the channel current bandwidth), the maximal rate which is used in determining the highest bitrate possible to convey the encoded copy along that channel, should also be changed dynamically to accommodate for the changes occurring at the channel.

Let us now consider a case where the method discussed above is used to multicast video data to a plurality of end users. Naturally, various end users are typically associated with communication channels having different qualities (e.g. different bandwidths). So let us assume that there is a plurality of m communication channels in the system, and the number of encoded copies to be conveyed is n, where m<n, for example, n−1, and wherein the communication channels have bitrates of C₁ . . . Cₘ, so that Cⱼ=Bⱼ, and wherein each of these communication channels is adapted to convey a respective one of the encoded copies. The selection of the encoded copy is made while ensuring that channel at bitrate Cⱼ will convey a video data encoded at a bitrate Bⱼ₋₁ together with an appropriate FEC transformation. The overall bitrate (after applying the FEC transformation onto the encoded video stream) that will be used for conveying this copy along that channel (channel j), is Bⱼ. In other words, the channel at bitrate Cⱼ will convey the information comprised in video stream j−1, which has been transformed to a higher bitrate upon applying a suitable FEC transformation thereon for erasure channels such as parity codes, fountain codes and the like. Thereafter, the handling of each of the channels is done along the lines exemplified hereinabove.

It should be understood that features described with respect to one embodiment may be used with other embodiments and that not all embodiments of the invention have all of the features shown in a particular figure. Variations of embodiments described will occur to persons of the art. Furthermore, the terms “comprise,” “include,” “have” and their conjugates, shall mean, when used in the claims, “including but not necessarily limited to.” The scope of the invention is limited only by the following claims.

1. A method for transmitting encoded video data over a packet switched network, comprising:
(i) providing a plurality of encoded copies of video data, wherein said plurality of encoded copies comprises at least two copies, each of which is encoded at a bitrate different from a bitrate at which any other of the at least two copies has been encoded (B₁, . . . Bⱼ . . . Bₙ);
(ii) transmitting one of the at least two encoded copies from a first end of a communication channel extending in the packet switched network towards a second end of the communication channel, wherein the transmitted copy is encoded at a first bitrate Bⱼ;
(iii) receiving the encoded copy at the second end of the communication channel and detecting its current error rate E_{detect};
(iv) at the first end of the communication channel, providing an indication associated with the detected error rate to enable transmitting from said first end of the communication channel another encoded copy of the at least two encoded copies, having a bitrate different from the first bitrate Bⱼ;
(v) transmitting a second encoded copy of the at least two encoded copies, having a second bitrate, wherein said second encoded copy is selected so that the second bitrate is substantially equal to a maximal rate at which that encoded copy of video data is recoverable at said second end with no noticeable apparent errors.

2. The method of claim 1, wherein said maximal rate at which said encoded copy of video data is recoverable at said second end, further comprises a rate at which an error correction code is applied onto said video data.

3. The method of claim 1, and wherein if the detected error rate E_{detect} is equal to or greater than a first error threshold E_{jTH} defined as an error tolerance of the encoded copy transmitted at the first bitrate Bj, then another encoded copy will be transmitted along said communication channel, where said other copy is encoded at a bitrate which is lower than the first bitrate Bⱼ.

4. The method of claim 1, and wherein if the detected error rate E_{detect} is less than a first error threshold E_{jTH} defined as an error tolerance of the encoded copy transmitted at the first bitrate Bⱼ, the method further comprising a step of associating the encoded copy of the first bitrate Bⱼ with an error correction overhead information being at a second bitrate E_{jOH}, so that the overall transmission rate of the combined streams which is equal to Bⱼ+E_{jOH} is equal to or greater than a second bitrate Bⱼ₊₁ associated with another encoded copy or an additional quality layer, and in case an encoded copy which is transmitted at the rate of Bⱼ+E_{jOH} is received at the second end of the communication channel at a measured error rate lower than a second error threshold E_{j+1TH} defined as the error tolerance of an encoded copy transmitted at a second bitrate Bⱼ₊₁, then another encoded copy of said at least two encoded copies will be transmitted along said communication channel, where the latter copy is encoded at a bitrate which is higher than the first bitrate Bⱼ.

5. The method of claim 1, wherein each of the at least two encoded copies are characterized as being either multiple synchronized single-bitrate streams each having its respective quality, or as a multi-layered single, video streams.

6. The method of claim 1, adapted for multicasting video data to a plurality of end users, associated with communication channels being at different qualities.

7. The method according to claim 3, wherein said maximal rate changes dynamically along with changes occurring at the communication channel.

8. A system for transmitting encoded video data encoded over a packet switched network, wherein said system comprises:
means for obtaining a plurality (n) of encoded copies of the video data, wherein said plurality of encoded copies comprises at least two copies, each of which is encoded at a bitrate different from a bitrate at which any other of the at least two copies has been encoded (B₁, . . . Bⱼ . . . Bₙ);
at least one processor operative to apply an appropriate FEC transformation onto at least one of the encoded video data streams, so that applying such a transformation onto a video data copy encoded at a bitrate Bⱼ would result in an encoded copy having a bitrate greater than or equal to a next bitrate Bⱼ₊₁;
at least one transmission means located at a first end of a communication channel extending in the packet switched network and adapted to transmit one of the at least two encoded copies encoded at a first bitrate Bⱼ towards a second end of the communication channel;
at least one receiver located at a second end of the communication channel, adapted to receive the encoded copy and to detect the communication channel error rate E_{detect};
at least one processor operative to enable providing an indication associated with the detected error rate, to enable transmitting another encoded copy of the at least two encoded copies by said at least one transmission means, wherein said another encoded copy has a bitrate different from the first bitrate Bⱼ;
and wherein said at least one transmission means is further operative to transmit a second encoded copy of the at least two encoded copies, having a second bitrate, wherein said second encoded copy is selected so that the second bitrate is substantially equal to a maximal rate at which that encoded copy of video data is recoverable at said second end with no noticeable apparent errors.

9. The system of claim 8, wherein said maximal rate at which said encoded copy of video data is recoverable at said second end, further comprises a rate at which an error correction code is applied onto said video data.

10. The system of claim 8, and wherein if the detected error rate E_{detect} is equal to or greater than a first error threshold E_{jTH} defined as an error tolerance of the encoded copy transmitted at the first bitrate Bj, then the at least one transmission means is operative to transmit another encoded copy along said communication channel, where said other copy is encoded at a bitrate which is lower than the first bitrate Bⱼ.

11. The system of claim 8, and wherein if the detected error rate E_{detect} is less than a first error threshold E_{jTH} defined as an error tolerance of the encoded copy transmitted at the first bitrate Bj, at least one processor is operate to associate the encoded copy of the first bitrate Bⱼ with an error correction overhead information being at a second bitrate E_{jOH}, so that the overall rate of the combined streams which is equal to Bⱼ+E_{jOH} is equal to or greater than a second bitrate Bⱼ₊₁ associated with another encoded copy or an additional quality layer, wherein the at least one transmission means is further operative to transmit another encoded copy at the rate of Bⱼ+E_{jOH′} wherein in case the at least one receiver which is further operative to receive another encoded copy at the rate of Bⱼ+E_{OH}, detects a measured error rate lower than a second error threshold E_{j+1TH} defined as the error tolerance of an encoded copy transmitted at a second bitrate Bⱼ₊₁, then said at least one transmitting means is further operative to transmit another encoded copy, where the latter copy is encoded at a bitrate which is higher than the first bitrate Bⱼ.

12. The system according to claim 10, wherein said maximal rate changes dynamically along with changes occurring at the communication channel quality.

13. A non-transitory computer-readable storage media storing one or more sequences of instructions which when loaded and executed by a computer system cause one or more processors to perform:
(i) obtaining a plurality of encoded copies of video data, wherein said plurality of encoded copies comprises at least two copies, each of which is encoded at a bitrate different from a bitrate at which any other of the at least two copies has been encoded (B₁, . . . Bⱼ . . . Bₙ);
(ii) selecting one of the at least two encoded copies to be transmitted from a first end of a communication channel extending in the packet switched network towards a second end of the communication channel, wherein the selected copy is encoded at a first bitrate Bⱼ;
(iii) receiving an indication characterizing a error rate E_{detect} that has been detected at the second end of the communication channel for the selected copy of the first bitrate Bⱼ;
(iv) based on the indication received, selecting a second encoded copy of the at least two encoded copies, having a bitrate different from the first bitrate Bⱼ, to be transmitted from the first end of the communication channel towards the second end thereof, wherein said second encoded copy is selected so that the second bitrate is substantially equal to a maximal rate at which that encoded copy of video data is recoverable at said second end with no noticeable apparent errors.

14. The non-transitory computer-readable storage media according to claim 13, wherein:
if the detected error rate E_{detect} is equal to or greater than a first error threshold E_{jTH} defined as an error tolerance of the encoded copy selected at the first bitrate Bⱼ, then:
another encoded copy will be selected for transmission along said communication channel, wherein said other copy is encoded at a bitrate which is lower than the first bitrate Bⱼ, and
if the detected error rate E_{detect} is less than a first error threshold E_{jTH} defined as an error tolerance of the encoded copy selected at the first bitrate Bⱼ, then:
associating the encoded copy of the first bitrate Bⱼ with an error correction overhead information being at a second bitrate E_{jOH}, so that the overall rate of the combined streams which is equal to Bⱼ+E_{jOH} is equal to or greater than a second bitrate Bⱼ₊₁ associated with another encoded copy, and in case an indication is obtained that an encoded copy which is transmitted at the rate of Bⱼ+E_{jOH} was received at the second end of the communication channel at a measured error rate lower than a second error threshold E_{j+1TH} defined as the error tolerance of an encoded copy transmitted at a second bitrate Bⱼ₊₁, then another encoded copy of said at least two encoded copies will be selected for transmission along said communication channel, where the latter copy is encoded at a bitrate which is higher than the first bitrate Bⱼ.

15. The method according to claim 4, wherein said maximal rate changes dynamically along with changes occurring at the communication channel.

16. The system according to claim 11, wherein said maximal rate changes dynamically along with changes occurring at the communication channel quality.
